(19) United States
(12) Patent Application Publication
(10) Pub. No.: US 2021/0118269 A1
(43) Pub. Date: Apr. 22, 2021

(54) POINT OF SALE TERMINAL WITH ADAPTIVE DISPLAY

(71) Applicant: SHOPIFY INC., Ottawa (CA)

(72) Inventors: ANDRZEJ PIOTR PALIGA, OTTAWA (CA); TOBIAS NEGELE, TORONTO (CA); RICARDO VAZQUEZ, OAKVILLE (CA)

(21) Appl. No.: 16/654,207

(22) Filed: Oct. 16, 2019

(51) Int. Cl. G07G 1/00; G06Q 30/06; G06Q 20/32; G06Q 20/20; G06F 3/0482; G06F 3/0484; H04W 4/021; G01S 19/51

(52) U.S. Cl. CPC G07G 1/0009; G06Q 30/0633; G06Q 30/0643; G06Q 20/3224; G01S 19/51; G06Q 20/202; G06F 3/0482; G06F 3/0484; H04W 4/021; G06Q 20/201

(57) ABSTRACT

The application relates to point of sale devices and associated methods with adaptive displays. A grid of GUI elements is displayed and a shopping cart. The GUI elements relate to items such as discounts, apps (for example loyalty apps), products, collections, to name a few examples. Rather than having a fixed selection, functionality and appearance of the GUI elements, with the provided devices and methods, the grid of GUI elements is adaptively updated based on context. The context may include, for example, customer information, for example the presence/absence of customer information, and specific information pertaining to a particular customer. The context may also include shopping cart information, for example whether there are items in the cart, which items are in the cart, value of items in the cart.

### FIELD

The application relates to point of sale terminals.

### BACKGROUND

Conventional Point of Sale Terminals (POST) have a fixed and inflexible layout. These fixed and inflexible layouts of such terminals generally offer limited functionality and make the POS terminals difficult to navigate. Conventional POS terminals are rented out to small businesses and the fixed layout of these devices is not able to provide merchant specific services and/or discounts. Although some conventional POS terminals may allow for a customized layout to offer merchant specific services and/or discounts, these customizations can only be done through limited proprietary interfaces owned by the manufacturers of such terminals. Consequently, such customizations also cost a substantial amount which can only be afforded by some businesses.

### SUMMARY

The application relates to point of sale devices and associated methods with adaptive displays. A grid of GUI elements is displayed and a shopping cart. The GUI elements relate to items such as discounts, apps (for example loyalty apps), products, collections, to name a few examples. Rather than having a fixed selection, functionality and appearance of the GUI elements, with the provided devices and methods, the grid of GUI elements is adaptively updated based on context. The context may include, for example, customer information, for example the presence/absence of customer information, and specific information pertaining to a particular customer. The context may also include shopping cart information, for example whether there are items in the cart, which items are in the cart, value of items in the cart.

According to one aspect of the present invention, there is provided a point of sale device with adaptive display (POSDAD) comprising: a processor and memory; a display; at least one user input device; computer executable instructions stored in said memory, executable by said processor to: display a grid and a shopping cart on the display, wherein the shopping cart contains a list of items for purchase, and their corresponding prices, and a total price amount, the list of items based on input from said at least one user input device, and wherein the grid comprises a set of grid GUI elements; update which grid GUI elements are included in said grid and/or a state of one or more of the grid GUI elements based on one or a combination of: presence or absence of a customer identifier; customer information associated with the customer identifier, if present; number of items in the shopping cart; which item(s) are in the shopping cart; value of item(s) in the shopping cart.

In some embodiments, each GUI element has the appearance of a tile.

In some embodiments, each grid GUI element is one of: an Icon that when selected triggers functionality that is directly included as part of the POSDAD; an informational icon that continuously displays selected information available on the POSDAD or to the POSDAD; an icon that when selected trigger execution of an App configured to operate on the POSDAD; a widget display.

In some embodiments, each GUI element is one of: an action GUI element that is an interface for a user to initiate a specific action; an app GUI element for displaying information from an App and/or control of an App; a widget GUI element for displaying information from a widget and/or control of a widget; a modal GUI element for displaying information from a modal and/or control of a modal; a collection GUI element that provides access to a particular collection of products which the user can then add to the shopping cart; a discount GUI element that provides an interface for a user to apply a discount; a link GUI element that provides access to a particular link; a products GUI element that provides access to a specific product which a user can then add to the cart.

In some embodiments, each GUI element has an associated state that is reflected in the display of the GUI element.

In some embodiments, each GUI element has an associated state that is reflected in the display of the GUI element, wherein each state is one of: active meaning the GUI element is available for selection by the user, or is actively displaying information relevant to the tile; contextual meaning the GUI element triggers different workflows based on shopping cart information and or customer information; inactive meaning the GUI element is not available for selection or is not actively displaying information relevant to the tile; and destructive meaning the GUI element triggers deletion of information relevant to the tile and/or other tiles.

In some embodiments, at least one GUI element triggers different workflows based on shopping cart information and/or customer information.

In some embodiments, the point of sale is further configured to maintain a plurality of shopping carts, each shopping cart for a respective customer, and to receive user input selecting one of the shopping carts, and to display the selected shopping cart, and to display the grid updated based on the selected shopping cart and the respective customer of the selected shopping cart.

In some embodiments, the point of sale device further comprises: a configuration engine for configuring behaviour of the grid, in terms of which GUI elements are displayed initially, and how the selection of the GUI elements and/or state of the GUI elements is updated based on the shopping cart and/or customer information.

In some embodiments, the point of sale device further comprises: a plurality of configurations for the grid in terms of which GUI elements are displayed initially, and how the selection of the GUI elements and/or state of the GUI elements is updated based on the shopping cart and/or customer information.

In some embodiments, the grid is maintained based on a determined one of the plurality of configurations, wherein the determined one is based on one or a combination of: which user is logged into the point of sale device; which store the point of sale device is located in; a location of the point of sale device; a user group or category associated with the user.

According to another aspect of the present invention, there is provide an apparatus comprising: a location processor with point of sale device (POSD) notification; the location processor having access to one or more databases containing customer information; the location processor with POSD notification is configured to: receive location information and a customer identifier from a mobile device indicating the mobile device has entered a particular store; obtain customer information associated with the customer identifier; provide the customer information to a POSD in the particular store.

In some embodiments, the location processor is part of the POSD.

In some embodiments, the location processor has access to one or more databases containing at least one geofence definition, and at least one geofence to store mapping that maps each geofence to a respective particular store; the location processor with POSD notification is configured to receive location information indicating the mobile device has entered a particular store by: receiving GPS location data from the mobile device; based on the GPS data, determining that the mobile device is located within one of the at least one geofence, based on the geofence that the mobile device is located within, determine the particular store from the geofence to store mapping.

In some embodiments, the location processor with POSD notification is configured to receive location information indicating the mobile device has entered a particular store by: receiving customer identification information from a scanning device associated with the particular store.

In some embodiments, the customer information comprises one or more of: profile picture; purchase history; payment information.

In some embodiments, the apparatus is further configured to transmit location specific data to the mobile terminal.

According to another aspect of the present invention, there is provided a method for execution by a point of sale device, the method comprising: displaying a grid and a shopping cart on the display, wherein the shopping cart contains a list of items for purchase, and their corresponding prices, and a total price amount, the list of items based on input from said at least one user input device, and wherein the grid comprises a set of grid GUI elements; updating which grid GUI elements are included in said grid and/or a state of one or more of the grid GUI elements based on one or a combination of: presence or absence of a customer identifier; customer information associated with the customer identifier, if present; number of items in the shopping cart; which item(s) are in the shopping cart; value of item(s) in the shopping cart.

In some embodiments, each grid GUI element is one of: an Icon that when selected triggers functionality that is directly included as part of the POSDAD; an informational icon that continuously displays selected information available on the POSDAD or to the POS DAD; an icon that when selected trigger execution of an App configured to operate on the POSDAD; a widget display.

In some embodiments, each GUI element is one of: an action GUI element that is an interface for a user to initiate a specific action; an app GUI element for displaying information from an App and/or control of an App; a widget GUI element for displaying information from a widget and/or control of a widget; a modal GUI element for displaying information from a modal and/or control of a modal; a collection GUI element that provides access to a particular collection of products which the user can then add to the shopping cart; a discount GUI element that provides an interface for a user to apply a discount; a link GUI element that provides access to a particular link; a products GUI element that provides access to a specific product which a user can then add to the cart.

In some embodiments, the method further comprises: updating a display of each GUI element to reflect an associated state of the GUI element.

In some embodiments, each state is one of: active meaning the GUI element is available for selection by the user, or is actively displaying information relevant to the tile; contextual meaning the GUI element triggers different workflows based on shopping cart information and or customer information; inactive meaning the GUI element is not available for selection or is not actively displaying information relevant to the tile; and destructive meaning the GUI element triggers deletion of information relevant to the tile and/or other tiles.

In some embodiments, the method further comprises: receiving a user input associated with one of the GUI elements; in response to receiving the user input associated with the one of the GUI elements, triggering one of a plurality of different workflows based on shopping cart information and/or customer information.

In some embodiments, the method further comprises: determining one of a plurality of configurations based on one or a combination of: which user is logged into the point of sale device; which store the point of sale device is located in; a location of the point of sale device; and a user group or category associated with the user; displaying the grid based on the determined one of a plurality of configurations.

### BRIEF DESCRIPTION OF THE DRAWINGS

Embodiments of disclosure will now be described with reference to the attached drawings in which:

FIG. 1A is a block diagram of a point of sale device with adaptive display (POSDAD), according to one embodiment;

FIG. 1B is a block diagram of an adaptive grid engine within a POSDAD, according to one embodiment;

FIG. 2A is an example of a POSDAD GUI depicting the grid and shopping cart region in a default state, according to one embodiment;

FIG. 2B is an example of a POSDAD GUI depicting the grid and shopping cart region post customization, according to one embodiment;

FIG. 2C is another example of a POSDAD GUI depicting the grid and shopping cart region post customization, according to one embodiment;

FIG. 3A is an example of a POSDAD GUI for initiating the creation of a new page to customize the grid, according to one embodiment;

FIG. 3B is an example of a POSDAD GUI that is generated following selection of “create new page” from the POSDAD GUI of FIG. 3A, according to one embodiment;

FIG. 4 is an example of a POSDAD GUI depicting the grid specifically configured with a “Ship to home” tile and a loyalty app tile, according to one embodiment;

FIG. 5 depicts three examples of POSDAD GUI workflows resulting from the contextual information of the “Ship to home” tile in the POSDAD GUI of FIG. 4, according to one embodiment;

FIG. 6 depicts three examples of POSDAD GUI workflows resulting from the contextual information of the loyalty app tile in the POSDAD GUI of FIG. 4, according to one embodiment;

FIG. 7 is an example of a POSDAD GUI user home page with various statistics on sales and a notifications bar to access new notifications and read notifications, according to one embodiment;

FIG. 8 is a block diagram of a system showing integration of the POSD with mobile device apps, according to one embodiment;

FIG. 9A is a block diagram of an e-commerce platform, according to one embodiment;

FIG. 9B is an example of a home page of a merchant, according to one embodiment;

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

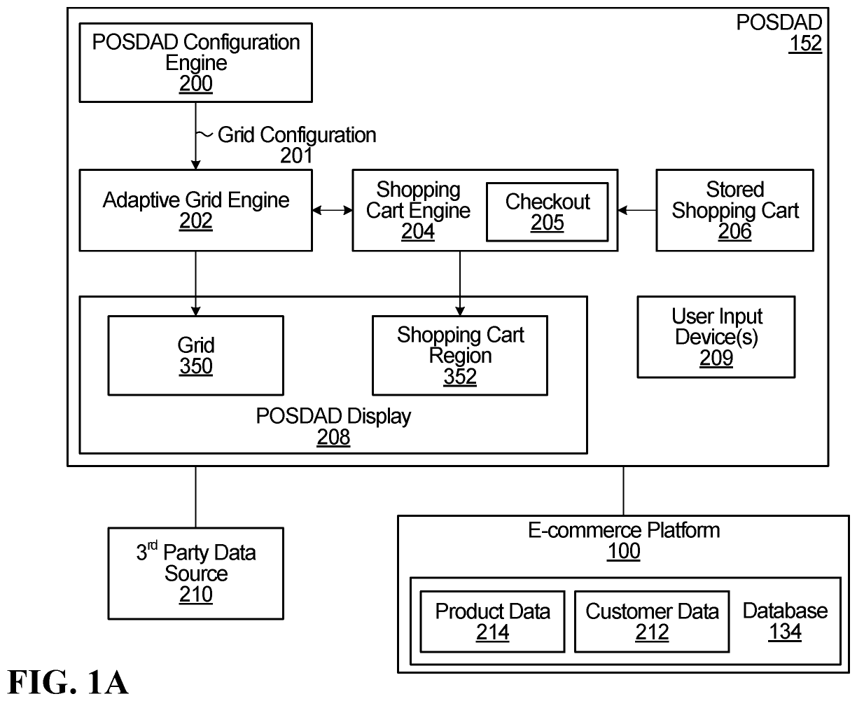

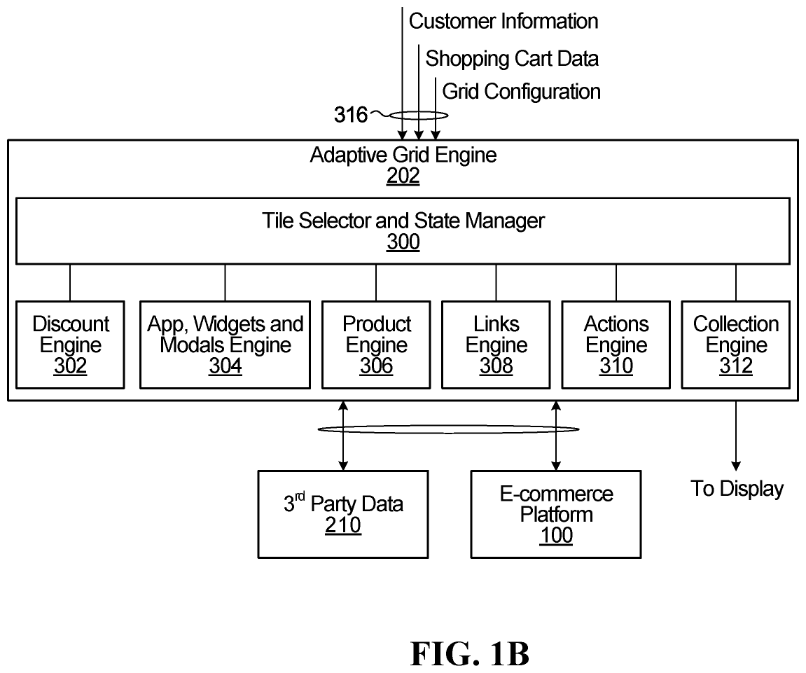

Referring now to FIG. 1A, shown is a block diagram of a point of sale device with adaptive display (POSDAD) 152. The main components of the POSDAD 152 are adaptive grid engine 202, a shopping cart engine 204, and a POSDAD display 208, and one or more user input devices 209.

The adaptive grid engine 202 controls a grid 350 displayed on the display 208. This involves controlling which tiles to include in the grid 350, controlling the states of the displayed tiles, updating tiles as necessary, executing actions triggered through the tiles. Further details of an example implementation of the adaptive grid engine 202 will be described below with reference to FIG. 1B.

The shopping cart engine 204 controls a shopping cart region 352 displayed on the display. This includes receiving user input adding and removing items from the shopping cart, and updating the display accordingly. The shopping cart engine 204 includes a checkout component 205 for executing a checkout for contents of the shopping cart. The shopping cart engine 204 has access to a storage 206 for storing shopping carts.

The user input devices 209 allow user input. If the display 208 is a touchscreen, then display 208 can be included as a user input device. Other user input devices may be present, for example, keyboard, mouse, RFID scanner, etc.

The POSDAD 152 may be connected to one or more 3rd party data sources 210. This may, for example, occur over one or more network connections where the 3rd party data is maintained and provided remotely.

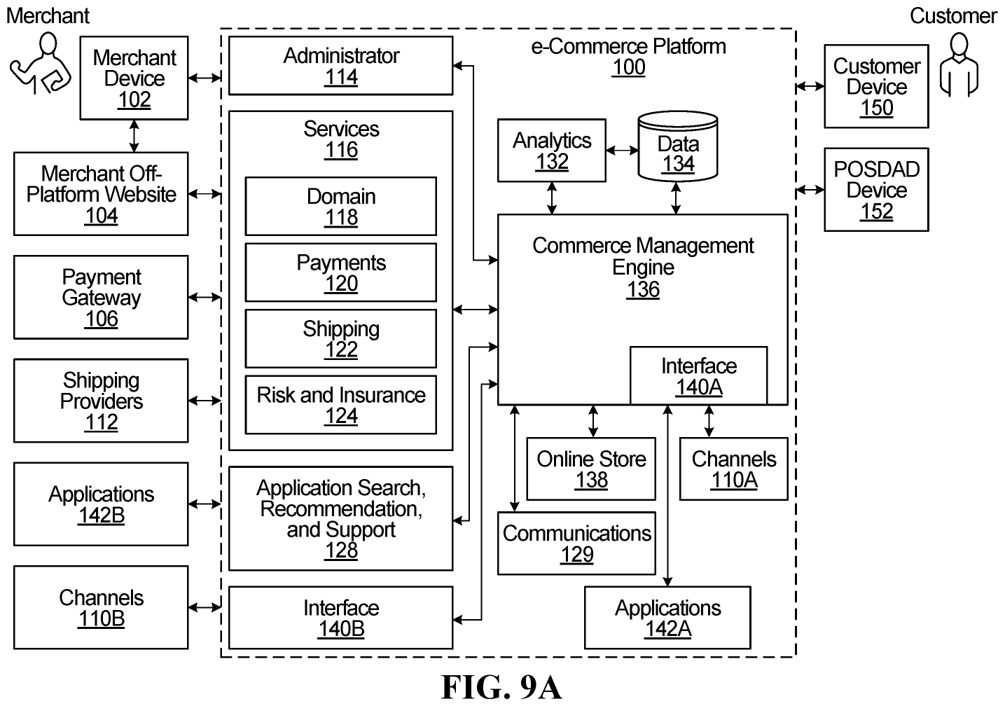

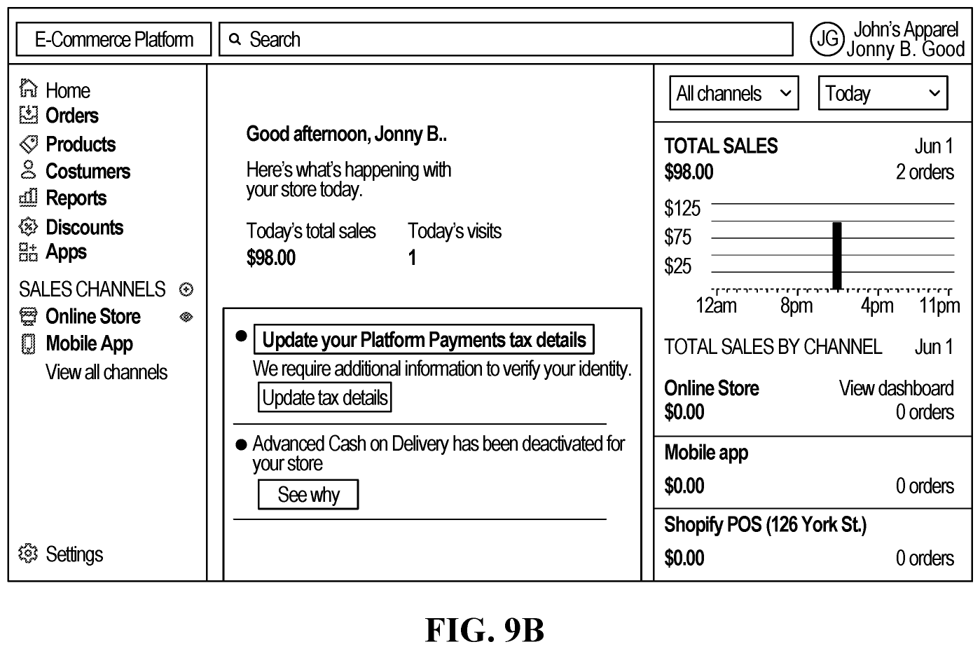

The POSDAD 152 may also be connected to an E-commerce platform 100. In this case, the POSDAD 152 becomes an interface for the E-commerce platform. An example of an E-commerce platform connected to a POSDAD 152 is depicted in FIG. 9A, which is described in detail below. In the example of FIG. 1A, the E-commerce platform 100 contains a database 134 containing customer data 212 and product data 214.

Also shown is a POSDAD configuration engine 200 through which the adaptive grid engine 202 is configured. A grid configuration 201 produced by the POSDAD configuration engine 200 is an input to the adaptive grid engine 202. While the POSDAD configuration engine 200 is shown as part of the POSDAD 152, in another embodiment, the POSDAD configuration engine is part of an E-commerce platform, and the grid configuration is received from the E-commerce platform. Multiple configurations may be generated using the POSDAD configuration engine. A specific configuration may be input to the adaptive grid engine 202, for example depending on the user, or the location of the POS.

Referring now to FIG. 1B, shown is a block diagram of the adaptive grid engine 202. The adaptive grid engine 202 receives as inputs 316 customer information (if available), shopping cart data, and a grid configuration. The adaptive grid engine 202 controls the display of the grid 350 on display 208. There is a tile selector and state manager 300 that determines which tiles to display in the grid 350, and also determines the state of each of the tiles. Tile state is discussed in detail below. The tile selector and state manager 300 makes these determinations based on the received customer information, shopping cart data, and grid configuration. The adaptive grid engine 202 may have access to third party data 210 and/or communicate with the e-commerce platform 100; this may be through other components of the POSDAD 152.

The adaptive grid engine 202 has a discount engine 302 for implementing discount tiles. When a discount tile is selected to be displayed, the discount engine controls the display of the tile, and controls user inputs selecting the application of a discount on one or more items in the shopping cart. There may be one or multiple discount tiles (or none) displayed at a given instant. The adaptive grid engine 202 has an apps, widgets and modals engine 304 for controlling/interacting with apps, widgets and modals. While shown as a single component, there may be multiple such components for interacting with specific apps, widgets and modals.

The adaptive grid engine 202 has a product engine 306 for implementing product tiles. This may be configured to display a specific product or products based on the customer information and or shopping cart information. Product engine also receives inputs selecting one or more of the products for addition to the shopping cart.

The adaptive grid engine 202 has a links engine 308 for implementing link tiles. This involves displaying a selected link in the link tile, and then responding to user input selecting the link.

The adaptive grid engine 202 has an actions engine 310 for implementing action tiles. There may be many different types of action tiles. Selection of a given action tile triggers execution of an associated workflow. An example of an action tile is “add customer”, which triggers execution of a workflow to add a customer to the shopping cart, which customer could be new or pre-existing.

The adaptive grid engine 202 has a collection engine 312 for implementing collection tiles. This may be configured to display a specific collection of product based on the customer information and or shopping cart information. Collection engine also receives inputs selecting one or more of the products from the collection for addition to the shopping cart.

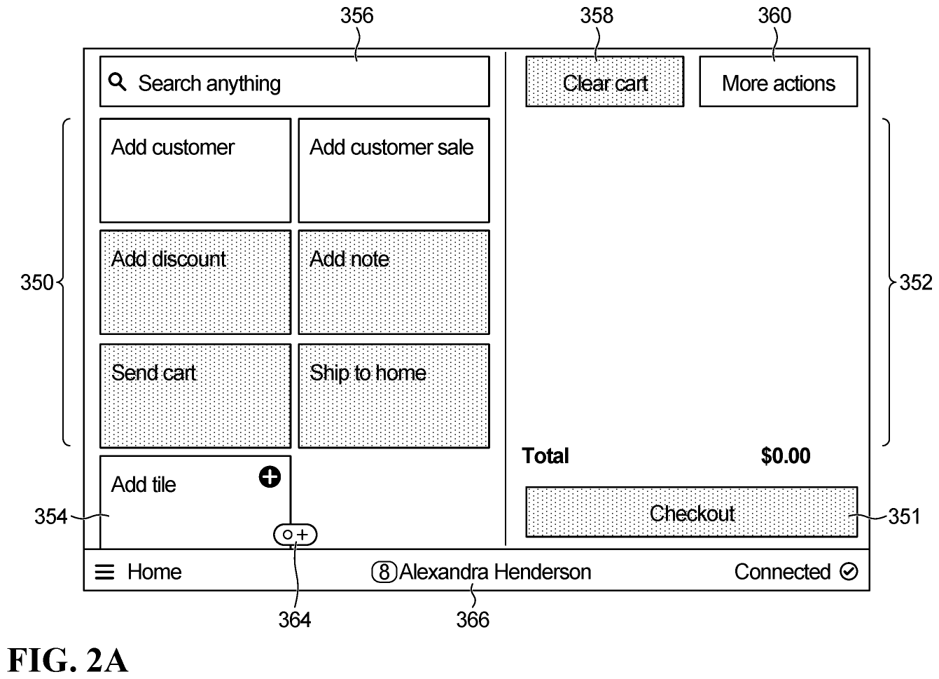

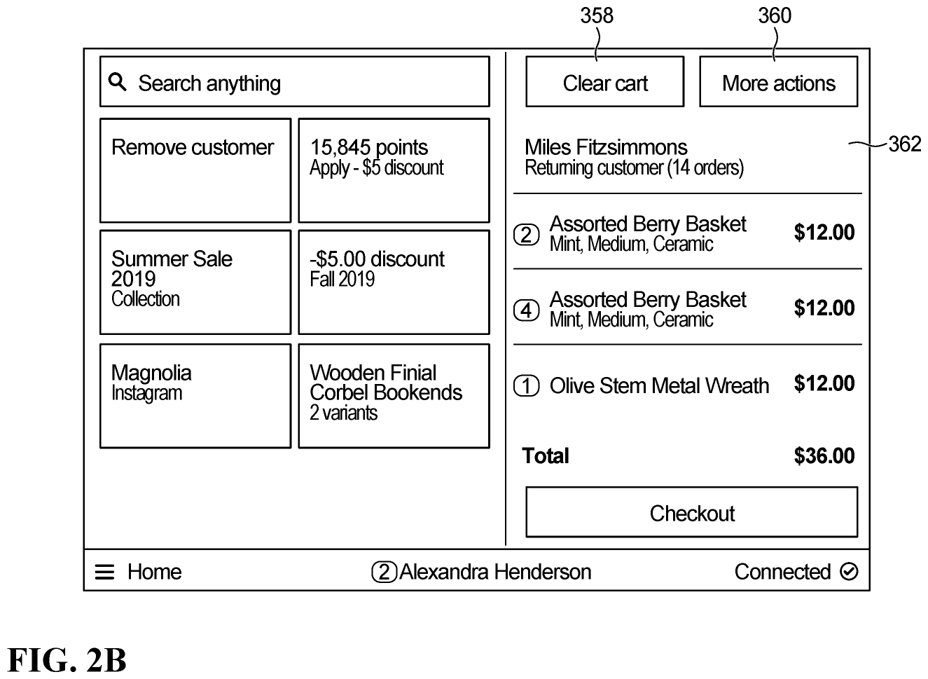

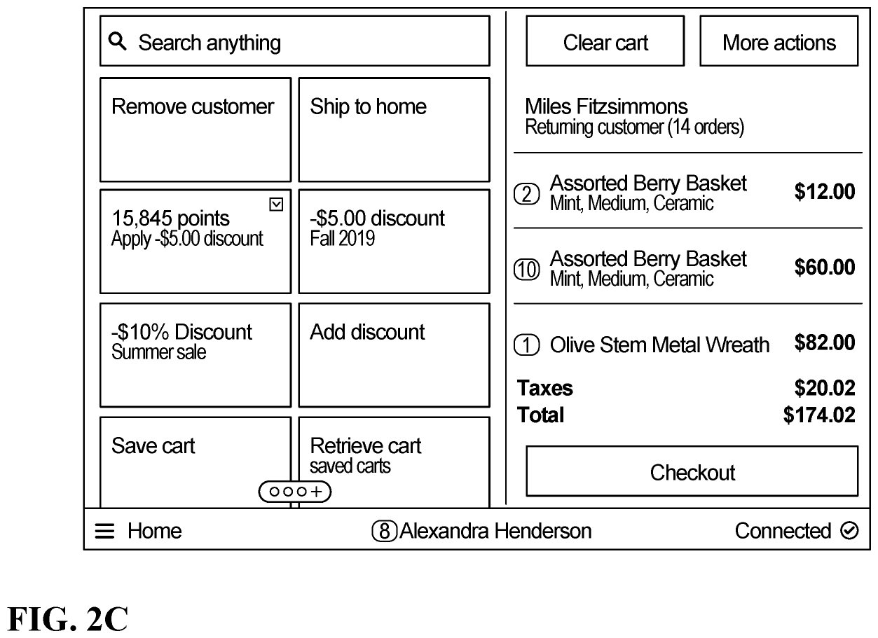

An example of a display produced by the POSDAD of FIG. 1A is shown in FIG. 2A which depicts a graphical user interface (GUI) of the new POSDAD. In the left hand side of the new POSDAD is a grid 350 containing a set of tiles. The configuration, content, and use of the tiles in the grid 350 are described in detail below. Also shown is a shopping cart region 352 in the right side for a shopping cart, depicted in an empty state in FIG. 2A. Additional features available through the depicted GUI include add tile button 354 for adding a tile to the grid 350, Search anything 356 for initiating a search (e.g. a global search that searches all elements, such as products, apps, data and functions), clear cart 358 for clearing the shopping cart in shopping cart region 352, additional actions available via the more actions operation 360 , and a checkout button 351 for initiating checkout. In some embodiments, there are multiple pages of tiles, and GUI element 364 is used to add page of tiles (selection of “+”), or to scroll, swipe, or tab between multiple pages when present. A user of the POSDAD is indicated at 366 via a username.

The grid 350 in POSDAD is an access point for all relevant, contextual, and important actions related to a given checkout. The grid 350 can be said to be “smart” in the sense that it is adaptively updated depending on one or a combination of the following:
a. Contents of the shopping cart in shopping cart region 352;
b. Identity of the customer and/or whether a customer has been identified; note that no customer indicated in FIG. 2A yet;
c. Identity of the POSDAD user;
d. the cohort of customers related to the customer and analytics results thereof;

In the following description, the combination of information that feeds into the adaptive update of the tiles and analytics conducted on this information is referred to as context information.

At a given instant, the relevant and important options available will change based on this adaptive updating of the grid 350. That is to say, each tile is updated to display relevant information and/or options depending upon the context information. In some embodiments, the display of a given tile is updated depending on the context information. In addition, or alternatively, the selection of which tiles are displayed may be updated depending on the context information. However, it may be a disadvantage for the tile layout to change too much during use, as this will make it more difficult for POSDAD users to understand and use the POSDAD efficiently and hinder the development of muscle memory. In some embodiments, tiles accomplishing similar end goals may be presented in a consistent manner across different contexts to meet the expectations of the user so as to reduce the effects on muscle memory.

The grid can be configured to be updated by:
a. Adding tiles based on context information;
b. Removing tiles based on context information;
c. Activating tiles based on context information;
d. Deactivating tiles based on context information;
e. Populating active tiles based on context information.

For example, tiles may be added/removed/activated/deactivated/populated when the cart goes from an empty state to a state with one item in the cart.

For example, tiles may be added/removed/activated/deactivated/populated when the cart goes from a state with one item in the cart to a state with more than one item in the cart.

For example, tiles may be added and/or removed and/or activated and/or deactivated and/or populated when the cart goes from a state where no customer information has been entered to a state where customer information has been entered.

For example, tiles may be added and/or removed and/or activated and/or deactivated and/or populated based on specific contents of the cart; for example when a specific product is added to the cart or removed from the cart, or a product from a set of products is added to the cart or removed from the cart.

For example, tiles may be added and/or removed and/or activated and/or deactivated and/or populated based on specific contents of the customer information; for example when shipping information is included in the customer information.

For example, tiles may be added and/or removed and/or activated and/or deactivated and/or populated based on a specific discount having been applied; for example when a first discount of one type is applied, other discounts of the same type may no longer be available, the types of discount and corresponding rules can be configured by the user. A specific example of this would be when one seasonal discount is applied other seasonal discount tiles would be deactivated, this deactivation is preconfigured by the user. A further example of a discount application, is when the system determines that the combination of shopping cart (i.e. a particular combination or number of products added to the cart or a transaction dollar amount), customer, and/or customer purchase history meets one or more predetermined conditions for a discount, a discount tile is generated and added to the grid.

The entire display is updated on a per-shopping cart basis. If the user has stored multiple shopping carts, but one is currently selected for display, that shopping cart will have associated items in the cart and possibly associated customer information if available. The grid or tile region 350 is updated to reflect the selected, and currently displayed, shopping cart. That is to say, the grid may be updated to display different sets of tiles for different carts.

### Grid Customization

The grid has a default state that includes a default set of checkout related tiles.

FIG. 2A depicts an example default state of the grid; it should be understood the grid default state can be configured on an application specific basis. In the illustrated example, the grid 350 includes the following tiles:
a. Add customer;
b. Add custom sale;
c. Add discount;
d. Add note;
e. Send cart; and
f. Ship to home.

The Add customer tile provides the ability to add information of a new customer and/or associate the present shopping cart with a specific customer. In some embodiments, the Add customer tile interfaces with a customer database containing information on existing customers. Then, the information for an already existing customer can be accessed, for example, in association with an email address or telephone number provided by a customer. In practice, it is not necessary to include customer information in all instances. Many customers do not want their information added to an order is a point of sale brick and mortar purchase.

The Add custom sale tile allows the user to add a custom sale. In some embodiments, the Add custom sale tile allows the user to offer a custom price on specific products that are customized on the request of the customer. For example, the merchant could allow a customer request to change the dimensions of a product if suitable, and then proceed to make the custom sale with a custom price based on the new dimensions of the product.

The Add discount tile allows the user to add a discount to be applied to the items in the shopping cart. Discounts are discussed in more detail below.

The Add note tile allows the user to add a note to the shopping cart. In some embodiments, the Add note tile can be replaced with a new tile named See notes when a note is added. The See notes tile can be representative of a folder that abstracts an underlying set of tiles containing notes created by the user.

The Send cart tile allows the user to send the cart to other POSDADs for reviewing and/or approval purposes. For example, a staff member may have to send the present cart to a POSDAD operated by a manager for review and/or approval if the sale exceeds a certain threshold amount.

The Ship to home tile provides access to an option of shipping the items in the cart to the home address of the customer. This may be useful in avoiding the need for the customer having to carry them, and/or in the case when not all items in the cart are available in the inventory in the store where the POSDAD is located.

While in the illustrated examples, the grid is composed of tiles. Tiles may include:
a. Icons that when selected trigger functionality that is directly included as part of the POSDAD;
b. Informational icons that continuously display selected information available on the POSDAD or to the POS DAD;
c. Icons that when selected trigger execution of an application (an app) that has been downloaded and is configured to operate on the POSDAD;
d. Widget display; widgets are like apps except that it is not necessary to tap on them to start the program; a widget display of a widget is updated automatically; the widget runs continuously in the background (e.g. without user input).

Tiles are used to access the various functionalities, more generally a set of icons and/or widgets can be used. However, ideally, at least some of the icons have the ability to display textual information directly. Collectively, these options for displaying information and accessing various functionalities are referred to herein as user interface elements.

### Grid Customization

Starting from this default state, the grid can be customized by or based on a user profile. The customizations available may be based on permissions associated with a user or a user profile, and may include for example:
a. Possible customizations for staff users, possibly different levels of staff;
b. Possible customizations for manager user, possibly different levels of managers.
c. Possible customizations for owner or merchant users.

Through the process of grid customization, tiles can be removed or rearranged and different types of tiles can be added.

The following is a specific example, of a set of possible tile types, but it should be understood that in the tile types may be implementation specific:
a. Actions—an action tile is the interface for a user to initiate a specific action. The add customer, add custom sale, add note, send cart, and ship to home tiles of FIG. 2A are examples of action tiles;
b. App—apps are discussed in further detail below;
c. Widget—widgets are discussed in further detail below;
d. Modal—modals are discussed in further detail below;
e. Collections—a collection tile provides quick access to a particular collection of products which the user can then add to the cart;
f. Discounts—a discount tile is the interface for the user to apply a particular discount; the Fall 2019 $5 discount tile in FIG. 2B is an example of a discount tile;
g. Links—a link tile provides efficient access to a particular link;
h. Products—a product tile provides quick access to a specific product which the user can then add to the cart.

During POSAD operation, each of the tiles, post POSDAD configuration, can be used to modify the cart somehow; tiles can also be considered cart modifiers.

A merchant can further customize their Grid by creating pages based on their preferences. This can allow a merchant to segment the tiles based on their own mental model. The customization will be different from merchant to merchant depending on their specific needs.

The add tile 354 is the entry point for a user to begin customization of the grid 350.

In some embodiments, during customization, a preview is available of a tile to be added to help in communicating to the user how the resultant GUI will appear and function.

FIG. 2B shows an example of the POSDAD GUI after customization. The example of FIG. 2B shows the POSDAD with POSDAD customization. In this case, the grid 350 includes the following set of tiles:
a. Remove customer—this is an example of an action tile;
b. a tile interfacing with a points account of the customer, showing an available discount—this is an example of an App tile;
c. a tile for a summer sale 2019 collection of products—this is an example of a collection tile;
d. a tile for a Fall 2019 $5 discount—this is an example of a discount tile;
e. a tile for Magnolia Instagram—this is an example of a link tile;
f. a tile for a specific product (Wooden Final Corbel Bookends) which indicates two possible variants of the specific product is available for purchase—this is an example of a product tile.

Also, in the example of FIG. 2B, the shopping cart is no longer empty, but rather 3 different items are included in the shopping cart. Also, the name of the customer is now displayed at 362. As a result, the “Add customer” tile now has been updated to show “Remove customer”.

FIG. 2C shows another example of the POSDAD GUI after customization. In this case, the grid 350 includes the following set of tiles:
a. Remove customer—this is an example of an action tile;
b. Ship to home—this is an example of a contextual action tile. More details are provided below.
c. a tile interfacing with a points account of the customer, showing an available discount—this is an example of an App tile;
d. a tile for a fall 2019 discount—this is an example of a discount tile;
e. a tile for a summer sale discount—this is an example of a discount tile;
f. a tile for “add discount”—this is an example of an action tile; when selected a discount is applied to the cart.
g. a tile for “save cart”—this is an example of an action tile; when selected the cart is saved for later access;
h. a tile for “retrieve cart”—this is an example of an action tile; when selected, a previously saved cart can be retrieved.

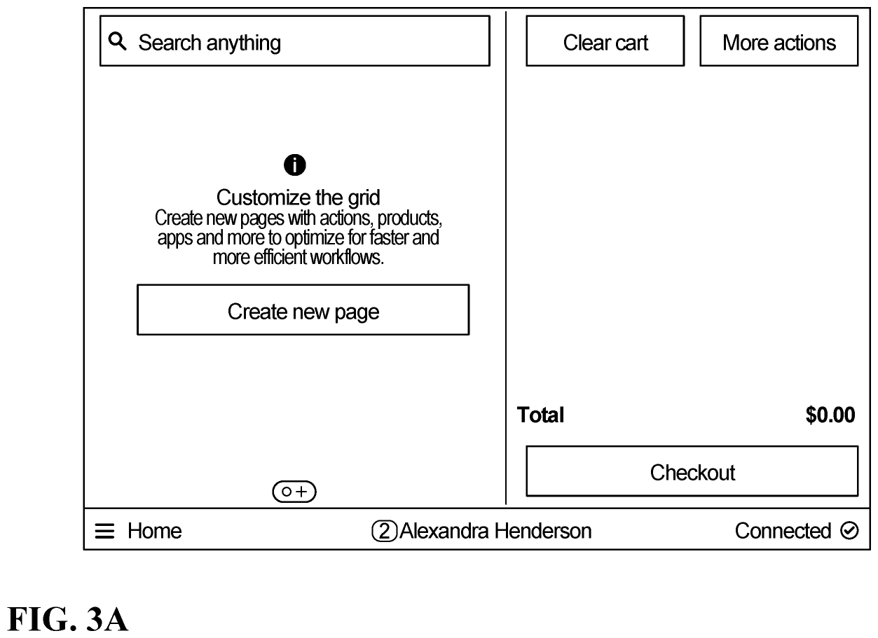

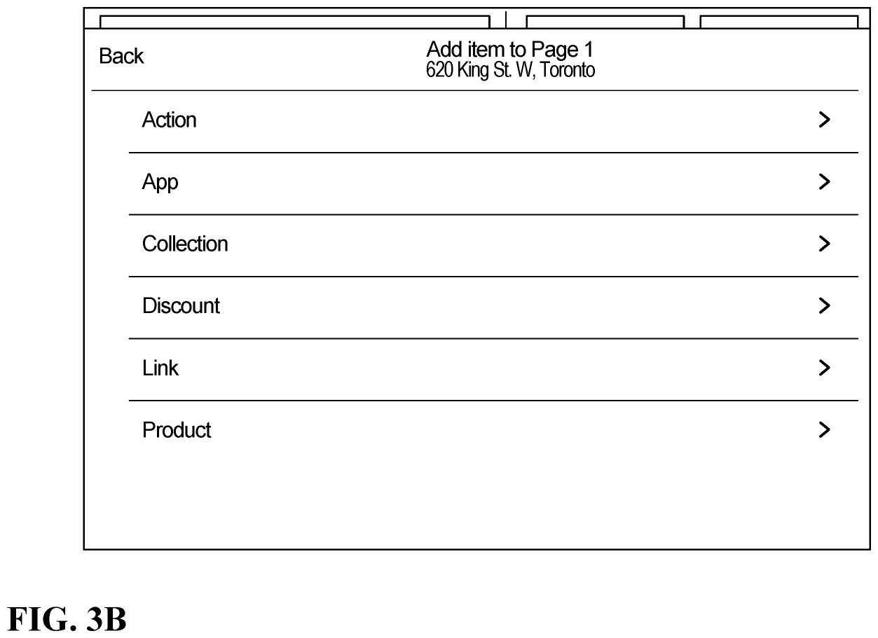

In some embodiments, a merchant can further customize their Grid by creating tile pages based on their preference. This can allow a merchant to segment the tiles based on their own mental model. FIG. 3A shows an example of a GUI for initiating the creation of a new page.

FIG. 3B shows an example of a GUI that is generated following selecting “create new page” from the GUI of FIG. 3A. This gives the user the option of adding tiles to the first page. A similar screen can be used to add tiles to other pages. The six types of tiles are listed, and each lead to menus of available tiles of the listed type. For example, selecting “Action” produces a menu of all the actions that are available for inclusion on the page for that merchant. The tiles that are configurable for a given merchant may vary from merchant to merchant, depending on their needs, and their subscriptions.

In some embodiments, a context specific subset of the tiles are available for use by the POSDAD user. In the illustrated example of FIGS. 2A, 2B and 2C available tiles are distinguished from unavailable tiles by the colour/shading of the text. In FIG. 2A, the text for the tiles “Add customer” and “Add custom sale” indicates these tiles are available, whereas the text for the remaining tiles indicates they are not available. In some embodiments, for one or more tiles, the preconditions for making the each tile active or not are preconfigured, and are not modifiable by a user. In some embodiments, for one or more tiles, the preconditions for making the each tile active or not are not preconfigured, although they may have default preconditions, and are modifiable by a user.

During use (i.e. in a non-configuration state), in an empty cart experience, certain tiles can be highlighted in some manner to recommend workflows. Other tiles become available as products are added to the cart and/or as customer information is added to the cart. During use, all of the tiles may be shown, regardless of their state, as this may be effective in reinforcing muscle memory to users.

In a specific example, the tiles on the grid can be in one of three different states with active/inactive being the default states. The colours of the tiles are an indication for the state they're in as follows:
a. Active and/or contextual=default tile type colour, e.g. green;
b. Inactive=grey;
c. Destructive=red.

These states are defined as follows:
a. a tile that is active is available for selection by the user, or is actively displaying information relevant to the tile;
b. A tile that is contextual can trigger different workflows depending on items in the cart and/or customer information. This may, for example involve surfacing different information on a tile and also directing the user to the area they should be focusing on next. This is based on the type of items that are present in the cart and the current state. This contextual information is related to and based on the items that are added to the cart. Item types in the cart may, for example, include customers, products, discounts and taxes;
c. A tile that is inactive is not available for selection or is not actively displaying information relevant to the tile and
d. A tile that is destructive allows the deletion of information from the system, for example, information regarding customers, products, or discounts. An example of such a tile is the Remove customer from the cart.

By adjusting the state of the tiles in a context specific manner, tiles can be used to surface valuable information in a “just-in-time” manner to users, such as loyalty point balance, the number of saved carts, recommended products, and more.

### Example 1 Ship to Home

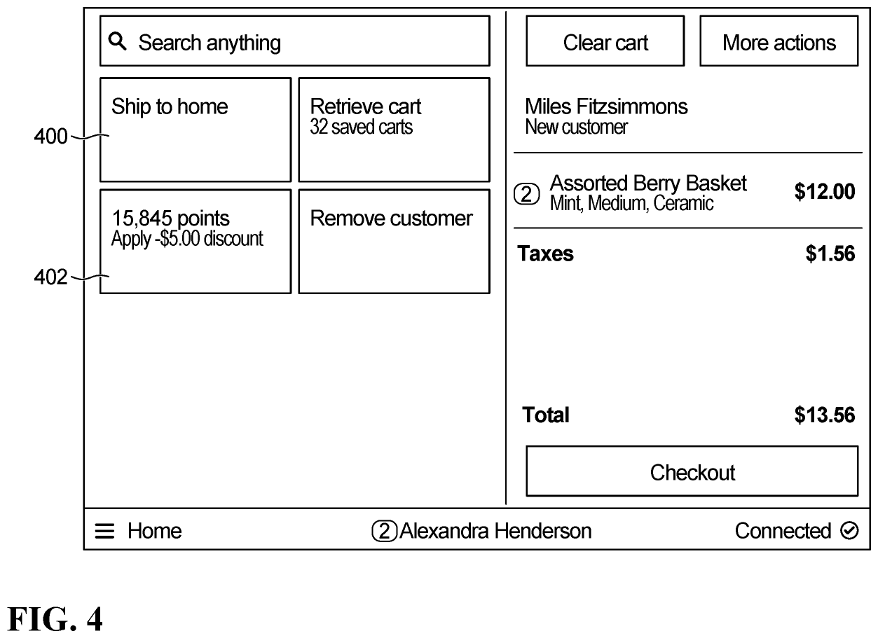

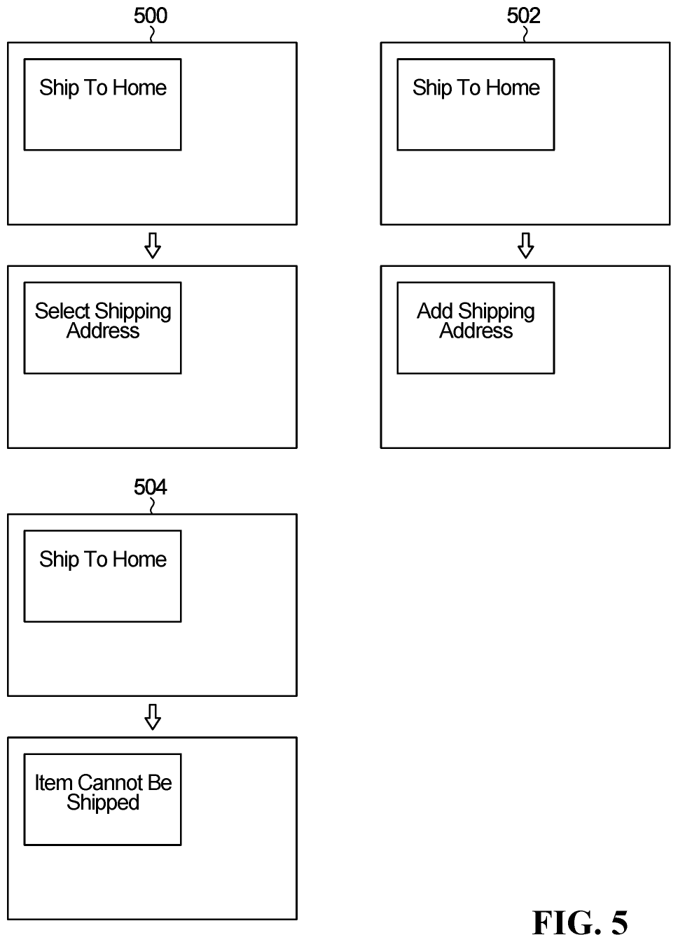

Referring to FIG. 4, shown is an example of the grid configured with a “Ship to home” tile 400 which displays contextual information and links to different flows depending on the items in the cart and/or other information associated with the customer. The following is an example of how the “Ship to home” tile can display contextual information based on what is in the cart, and based on whether an address for the customer is already available. In this example, there are three different workflows that can be triggered. The three workflows are depicted in FIG. 5, where only details relevant to the described workflows are depicted.

In the first workflow 500, if the customer is a returning customer and if a customer address has been recorded before, the ship to home tile 400 is updated to show “Select shipping address”. Tapping on the tile allows the user to select and confirm the shipping address.

In the second workflow 502, if the customer is new, the ship to home tile 400 is updated to show “Add shipping address”, which when tapped will send the user to a form field where they can enter the customer's address.

In the third workflow 504, if some of the products that were added to the cart cannot be shipped, the ship to home tile 400 will include a label indicating “[Number] items can't be shipped”. Tapping on the tile allows the user to identify and edit or remove those products.

### Example 2 Loyalty App

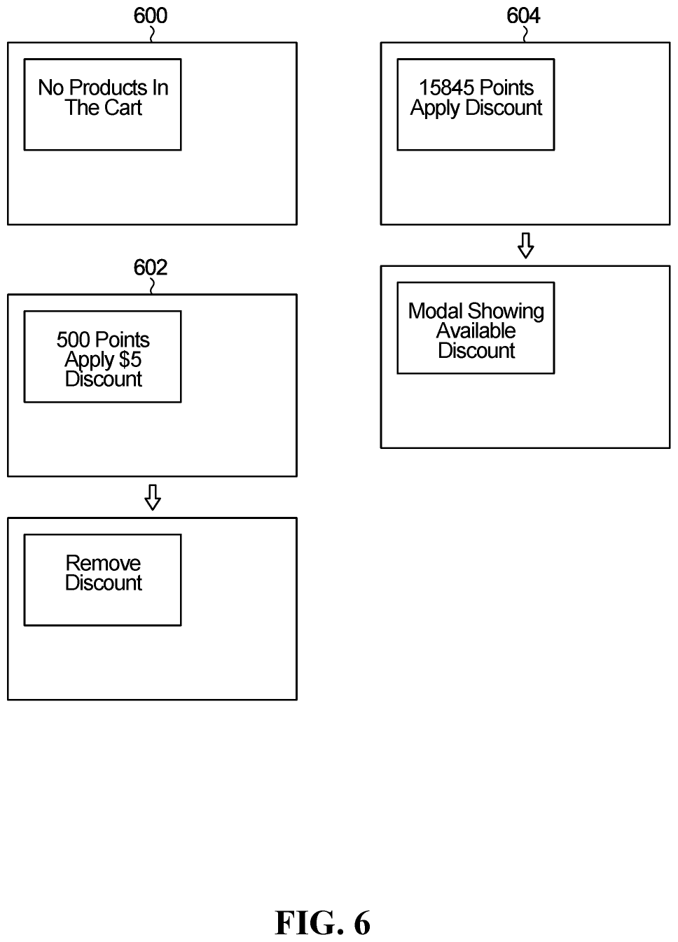

Referring again to FIG. 4, also shown is an example of the grid configured with a loyalty app tile 402 which displays contextual information pertaining to a loyalty app and which leads to different flows based on the items in the cart. In this example, there are three different workflows that can be triggered. The three workflows are depicted in FIG. 6 where only details relevant to the described workflows are depicted.

In a first workflow 600, if the user added (associated) a customer to (with) the cart but no products, the tile would remain inactive and show a label that says “No products in the cart”.

In a second workflow 602, if both a customer (who already collected loyalty points) and products were added to the cart, the loyalty app tile becomes active. If there is only one type of discount available (based on the amount of loyalty points accumulated by the customer), tapping on the tile will automatically apply the discount to the cart. The state of the tile would then change to a destructive state and tapping on the tile would remove the discount from the cart.

In a third workflow 604, if there are multiple discount options to choose from, tapping on the tile will show a modal where all available discounts are listed.

### App Actions

In some embodiments, Apps play an important role in the POSDAD and they are able to add or insert information in different ways:
1. insert information on the tile; in this case the App directly inserts the information for display.
2. show more contextual information in a modal; a modal in this context is a portal for another App to display information. In this case, the information from the app passes through the modal for display.
3. Apps can insert content through notifications in the home view. The home view is discussed in further detail below.

In some embodiments, the system is configured to allow a set of POSDAD configurations to be stored and maintained. The configured POSDAD configurations can then be assigned:
a. On a per user basis—one of the configured POSDAD configurations is assigned or selected per user or per user profile;
b. On a per location basis—one of the configured POSDAD configurations is assigned for all users at a given location, with this approach, the POSDAD configuration is synced across all users at a given location. The location can be defined on a geographical basis, or on a per store basis, or an a per group of stores basis;
c. On a user group or user category basis—the user group can be defined to include a specific set of users, or all users that satisfy some criteria can be said to belong to the user group, in which case the user group contains a category of users.

### Discount

A discount tile may be used to provide a fixed discount, or a discount that is based on the current state of the cart, or a set of discounts that the user can select between. The discount may also be dependent on the customer.

### Home View

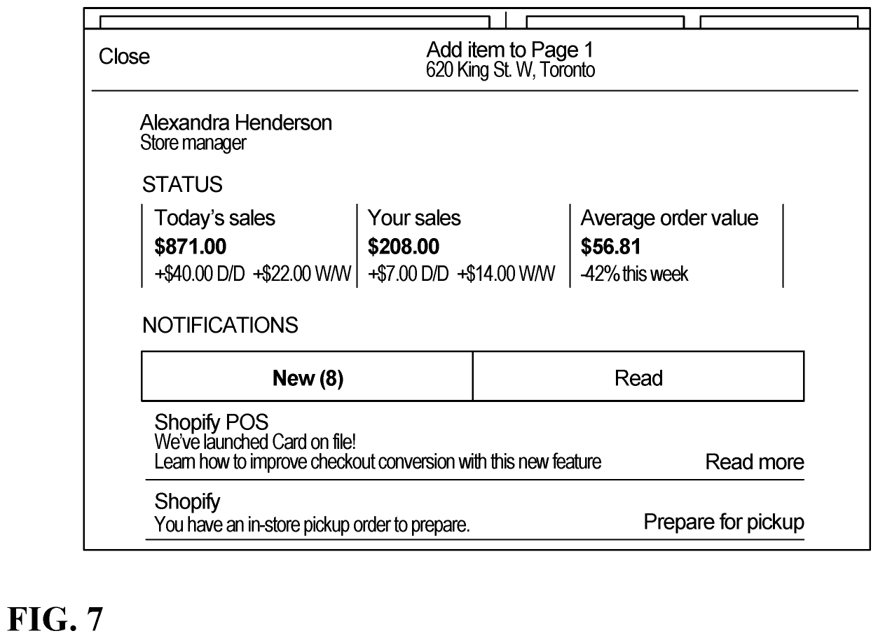

In some embodiments, the POSDAD includes a user home page. This may, for example be selectable by clicking on the username 366 of the logged in or registered user. An example is depicted in FIG. 7 which shows a user home page for store manager “Alexandra Henderson”. Shown are various statistics, including “today's sales”, “your sales”, and “average order value”. In addition, there is a notifications bar to access new notifications and read notifications.

### Customer Location Integration

In some embodiments, a POSD (for example, a POSD with adaptive display as described above, or another POSD) can be configured to operate based on customer location information, that is information indicative of a current location of a particular customer. For example, a location processor in communication with the POSD could determine when a customer has entered a particular store based on customer identification information (e.g. a customer ID) received from a scanning device (e.g. card reader, code scanner, biometric recognition device, etc.) associated with the particular store. In that case, the customer location information could include a customer ID associated with a store ID. Alternatively, the determination could also be based on GPS location information received from a particular customer mobile device (e.g. via a mobile device app) and geolocation information, for example geolocation fences, for stores that have the provided POSD. Based on the location information, and the geolocation information, the location processor can determine when a user has entered a given store, and can send or trigger the transmission of information concerning the customer to one or more POSDs in that store. As an example, the POSD may display a tile in respect of the customer. The tile may, for example, surface information such as a profile picture for the customer, payment information, purchase history, discounts based on loyalty points etc.

The mobile device does not need to have the sole purpose of pushing or sending the location information to the location processor. For example, a mobile device App may be provided that allows customers to track purchases and shipments. The App can be configured to have the secondary purpose of pushing location information to the location processor. As it can be difficult to persuade customers to download new Apps, the inclusion of this functionality in an existing App, or a modification (upgrade) to an existing App, may lead to larger customer uptake.

In some embodiments, the interaction between the POSD and the App can be two-way:
a. POSD is made aware that a customer is on the store premises;
b. Data is pushed to the App when the customer is on the store premises. For example, the customer can be informed of discounts available/promotions.

In some embodiments, the amount of information displayed in the POSD is adjusted as a function of how many customers are in the store that have been tracked in this manner. For example, where there is a single customer (or fewer than some threshold number of customers), a dedicated tile may be displayed for each customer. When the number of customers exceeds a threshold, a single non-customer-specific tile may be used to access the customer-specific tiles.

As described above, in some embodiments, tiles can be spread across multiple pages. In some embodiments, a tile can be representative of a folder that abstracts an underlying set of tiles. Tapping on such a tile provides access to the underlying set of tiles.

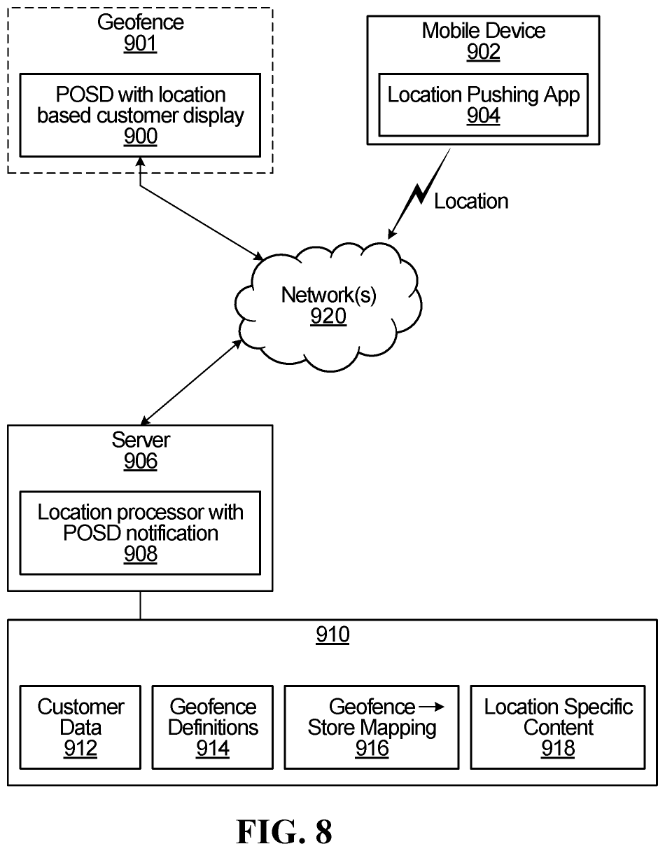

FIG. 8 is a block diagram of a system showing integration of the POSD with mobile device apps. Shown is a point of sale device with location based customer display (POSD) 900 configured to display customer information as described below. In some embodiments POSD 900 is a POSDAD in accordance with one of the previously described embodiments. Also shown is a mobile device 902 that has a location pushing app 904. The mobile device 902 is shown outside an area defined by a geofence 901. The geofence 901 may for example be consistent with the perimeter of a particular store where the POSD is located.

Also shown is a server 906 equipped with a location processor with POSD notification 908, hereinafter simply location processor. The server 906 is connected to a database 910 that includes customer data 912, geofence definitions 914, geofence to store mappings 916, and location specific content 918. Also shown is a network 920, which represents any networks that might be situated between the various components; this might include for example a mobile network through which the mobile device 902 obtains wireless access, possibly a local area network for a retail location where the POSD 900 is situated, possibly a local area network to which the server 906 is connected, the internet, interconnecting the other networks.

There may be a dedicated server for the described location processing functionality. In some embodiments, the server is part of a larger e-commerce platform, for example, as described below with reference to FIG. 9A. In some embodiments, the location processor is built into the POSD itself in which case there is no separate server with location processor. In this case, some or all of the mentioned above to be stored in database 910 may be stored elsewhere in the e-commerce platform than in the POSD itself.

The server 906 has access to customer information stored in the customer database 912. This can, for example, include prior purchase information, credit history, etc. The customer database 912 may be part of/maintained by an e-commerce platform. The geofence definitions 914 includes one or more geofence definitions. Each geofence definition defines a geographical area of interest. Typically, the geofence will be associated with the boundaries of a particular store. There may be multiple geofence definitions for multiple different stores. For the example of FIG. 8, the geofence definitions 914 will include a definition of geofence 901. The geofence to store mapping 916 maps each geofence to a specific store located within the geofence. The mapping may also list/identify the POSDs situated in that store. Alternatively, the geofence to store mappings may map the geofence directly to the POSDs of a store situated within the geofence. In the example of FIG. 8, the geofence to store mappings 916 will include a mapping from geofence 901 to a store containing POSD 900. The location specific content 918 contains content, provided by retailers or an e-commerce platform, that can be provided to the user via their location pushing app, dependent on their location.

In operation, the location pushing app 904 on the mobile device 902 pushes location information through the networks 920 to the server 906. The app also pushes enough information to the server 906 for the customer to be identified. This can be a user name, phone number, email address etc. The location pushing app 904 may push the location information, for example, on a periodic basis or using a request-based mechanism (e.g. using location requests from the location processor). The location pushing app 904 may be an app specifically provided for this purpose, or this functionality can be added to another app. Ideally, if there already exists an app facilitating interaction with an e-commerce platform associated with the system (now shown), then such an app is modified to include the location pushing functionality. In that way, customers who already have that app will not need to download another app.

The location information is processed by the location processor 908. The location processor 908 determines if the current location of the mobile device 902, as indicated by the location information, is inside one of the geofences defined in the geofence definitions 914, and identifies the specific geofence for which this is the case. For the example of FIG. 8, the location processor 908 would determine that the mobile device 902 is within geofence 901. If it is, then the geofence to store mappings 916 are consulted to determine one or more POSDs associated with the specific geofence. In the illustrated example, the POSD 900 is determined to be associated with geofence 901.

Next, based on the customer identity as determined from a message of mobile device 902 containing the pushed location information, the customer database 912 is consulted to obtain information respecting the corresponding customer. This information is then sent through networks 920 to the POSDs associated with a store identified by the geofence to store mapping 916. In the illustrated example, this is sent to POSD 900.

Next, the POSD 900 that receives the information makes such information available to a user. In some embodiments, a profile picture of the customer and/or other components of the received customer information are presented on a display of the POSD 900.

In some embodiments, where location specific content 918 is implemented, the location processor 908 also determines location specific content associated with the determined geofence, and pushes this to the mobile device 902. For example, there might be special offers that are provided to the customer.

With reference to FIG. 9A, an embodiment e-commerce platform 100 is depicted for providing merchant products and services to customers. While the disclosure throughout contemplates using the apparatus, system, and process disclosed to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the platform 100. Merchants may utilize the e-commerce platform 100 for managing commerce with customers, such as by implementing an e-commerce experience with customers through an online store 138, through channels 110A-B, through POSDADs 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 152 in a physical store of a merchant are linked into the e-commerce platform 100, where a merchant off-platform website 104 is tied into the e-commerce platform 100, such as through ‘buy buttons’ that link content from the merchant off platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The client device web browser (or other application) then renders the page accordingly.

In embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their website through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog POSDADs or static pages and publish them to their online store 138, such as through blogs, articles, and the like, as well as configure navigation menus. Merchants may upload images (e.g., for products), video, content, data, and the like to the e-commerce platform 100, such as for storage by the system (e.g. as data 134). In embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

FIG. 2B depicts a non-limiting embodiment for a home page of an administrator 114, which may show information about daily tasks, a store's recent activity, and the next steps a merchant can take to build their business. In embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In embodiments, the merchant may be able to access the different sections of administrator 114 by using the sidebar, such as shown on FIG. 2B. Sections of the administrator 114 may include various interfaces for accessing and managing core aspects of a merchant's business, including orders, products, customers, available reports and discounts. The administrator 114 may also include interfaces for managing sales channels for a store including the online store, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g. via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's back account (e.g., when using capital), and the like. These systems may have Sarbanes-Oxley Act (SOX) compliance and a high level of diligence required in their development and operation. The financial facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 9A, in embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In embodiments, an application 142A may be provided by the same party providing the platform 100 or by a different party. In embodiments, an application 142B may be provided by the same party providing the platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In embodiments, rather than violating the isolation principle, it may be preferred to move these components out of the commerce management engine 136 and into their own infrastructure within the e-commerce platform 100.

In embodiments, the e-commerce platform 100 may provide for a platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through application search, recommendations, and support 128. In embodiments, core products, core extension points, applications, and the administrator 114 may be developed to work together. For instance, application extension points may be built inside the administrator 114 so that core features may be extended by way of applications, which may deliver functionality to a merchant through the extension.

In embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension/API 140A-B, help make products easy to view and purchase in a fast growing marketplace. In embodiments, partners, application developers, internal applications facilities, and the like, may be provided with a software development kit (SDK), such as through creating a frame within the administrator 114 that sandboxes an application interface. In embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In embodiments, when a change related to an update event subscription occurs, the commerce management engine 136 may POSDAD a request, such as to a predefined callback URL. The body of this request may contain a new state of the object and a description of the action or event. Update event subscriptions may be created manually, in the administrator facility 114, or automatically (e.g., via the API 140A-B). In embodiments, update events may be queued and processed asynchronously from a state change that triggered them, which may produce an update event notification that is not distributed in real-time.

In embodiments, the e-commerce platform 100 may provide application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In embodiments, the payment gateway 106 may accept international payment, such as integrating with leading international credit card processors. The card server environment may include a card server application, card sink, hosted fields, and the like. This environment may act as the secure gatekeeper of the sensitive credit card information. In embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that doesn't provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In embodiments, the e-commerce platform 100 may enable merchants to keep track of changes to the contract of sales over time, such as implemented through a sales model component (e.g., an append-only date-based ledger that records sale-related events that happened to an item).

The e-commerce platform 100 may be providing sales channels for multiple merchants, for their respective customers, and for varying types of merchandise. Payment gateways 106 are provided by the e-commerce platform or by external parties to process transactions in an e-commerce environment.

The E-commerce platform of FIG. 9A can be used to implement embodiments of the invention, by interfacing with the new POSDAD 152, by providing product and customer information to the POSDAD.

Numerous modifications and variations of the present disclosure are possible in light of the above teachings. It is therefore to be understood that within the scope of the appended claims, the disclosure may be practiced otherwise than as specifically described herein.

1. A point of sale device with adaptive display (POSDAD) comprising:
a processor and memory;
a display;
at least one user input device;
computer executable instructions stored in said memory, executable by said processor to:
display a grid and a shopping cart on the display, wherein the shopping cart contains a list of items for purchase, and their corresponding prices, and a total price amount, the list of items based on input from said at least one user input device, and wherein the grid comprises a set of grid GUI elements;
update which grid GUI elements are included in said grid and/or a state of one or more of the grid GUI elements based on one or a combination of:
presence or absence of a customer identifier;
customer information associated with the customer identifier, if present;
number of items in the shopping cart;
which item(s) are in the shopping cart;
value of item(s) in the shopping cart.

2. The POSDAD of claim 1 wherein each GUI element has the appearance of a tile.

3. The point of sale device with adaptive display of claim 1 wherein each grid GUI element is one of:
an Icon that when selected triggers functionality that is directly included as part of the POS DAD;
an informational icon that continuously displays selected information available on the POSDAD or to the POSDAD;
an icon that when selected trigger execution of an App configured to operate on the POSDAD;
a widget display.

4. The point of sale device with adaptive display of claim 1 wherein each GUI element is one of:
an action GUI element that is an interface for a user to initiate a specific action;
an app GUI element for displaying information from an App and/or control of an App;
a widget GUI element for displaying information from a widget and/or control of a widget;
a modal GUI element for displaying information from a modal and/or control of a modal;
a collection GUI element that provides access to a particular collection of products which the user can then add to the shopping cart;
a discount GUI element that provides an interface for a user to apply a discount;
a link GUI element that provides access to a particular link;
a products GUI element that provides access to a specific product which a user can then add to the cart.

5. The point of sale device with adaptive display of claim 1 wherein each GUI element has an associated state that is reflected in the display of the GUI element.

6. The point of sale device with adaptive display of claim 1 wherein each GUI element has an associated state that is reflected in the display of the GUI element, wherein each state is one of:
active meaning the GUI element is available for selection by the user, or is actively displaying information relevant to the tile;
contextual meaning the GUI element triggers different workflows based on shopping cart information and or customer information;
inactive meaning the GUI element is not available for selection or is not actively displaying information relevant to the tile; and
destructive meaning the GUI element triggers deletion of information relevant to the tile and/or other tiles.

7. The point of sale device with adaptive display of claim 1 wherein at least one GUI element triggers different workflows based on shopping cart information and/or customer information.

8. The point of sale device of claim 1 further configured to maintain a plurality of shopping carts, each shopping cart for a respective customer, and to receive user input selecting one of the shopping carts, and to display the selected shopping cart, and to display the grid updated based on the selected shopping cart and the respective customer of the selected shopping cart.

9. The point of sale device of claim 1 further comprising:
a configuration engine for configuring behaviour of the grid, in terms of which GUI elements are displayed initially, and how the selection of the GUI elements and/or state of the GUI elements is updated based on the shopping cart and/or customer information.

10. The point of sale device of claim 1 comprising:
a plurality of configurations for the grid in terms of which GUI elements are displayed initially, and how the selection of the GUI elements and/or state of the GUI elements is updated based on the shopping cart and/or customer information.

11. The point of sale device of claim 10 wherein the grid is maintained based on a determined one of the plurality of configurations, wherein the determined one is based on one or a combination of:
which user is logged into the point of sale device;
which store the point of sale device is located in;
a location of the point of sale device;
a user group or category associated with the user.

12. An apparatus comprising:
a location processor with point of sale device (POSD) notification;
the location processor having access to one or more databases containing customer information;
the location processor with POSD notification is configured to:
receive location information and a customer identifier from a mobile device indicating the mobile device has entered a particular store;
obtain customer information associated with the customer identifier;
provide the customer information to a POSD in the particular store.

13. The apparatus of claim 12 comprising the POSD, wherein the location processor is part of the POSD.

14. The apparatus of claim 12 wherein:
the location processor has access to one or more databases containing at least one geofence definition, and at least one geofence to store mapping that maps each geofence to a respective particular store;
the location processor with POSD notification is configured to receive location information indicating the mobile device has entered a particular store by:
receiving GPS location data from the mobile device;
based on the GPS data, determining that the mobile device is located within one of the at least one geofence,
based on the geofence that the mobile device is located within, determine the particular store from the geofence to store mapping.

15. The apparatus of claim 12 wherein the location processor with POSD notification is configured to receive location information indicating the mobile device has entered a particular store by:
receiving customer identification information from a scanning device associated with the particular store.

16. The apparatus of claim 12 wherein the customer information comprises one or more of:
profile picture;
purchase history;
payment information.

17. The apparatus of claim 12 further configured to transmit location specific data to the mobile terminal.

18. A method for execution by a point of sale device, the method comprising:
displaying a grid and a shopping cart on the display, wherein the shopping cart contains a list of items for purchase, and their corresponding prices, and a total price amount, the list of items based on input from said at least one user input device, and wherein the grid comprises a set of grid GUI elements
updating which grid GUI elements are included in said grid and/or a state of one or more of the grid GUI elements based on one or a combination of:
presence or absence of a customer identifier;
customer information associated with the customer identifier, if present;
number of items in the shopping cart;
which item(s) are in the shopping cart;
value of item(s) in the shopping cart.

19. The method of claim 18 wherein each grid GUI element is one of:
an Icon that when selected triggers functionality that is directly included as part of the POS DAD;
an informational icon that continuously displays selected information available on the POSDAD or to the POSDAD;
an icon that when selected trigger execution of an App configured to operate on the POSDAD;
a widget display.

20. The method of claim 18 wherein each GUI element is one of:
an action GUI element that is an interface for a user to initiate a specific action;
an app GUI element for displaying information from an App and/or control of an App;
a widget GUI element for displaying information from a widget and/or control of a widget;
a modal GUI element for displaying information from a modal and/or control of a modal;
a collection GUI element that provides access to a particular collection of products which the user can then add to the shopping cart;
a discount GUI element that provides an interface for a user to apply a discount;
a link GUI element that provides access to a particular link;
a products GUI element that provides access to a specific product which a user can then add to the cart.

21. The method of claim 18 further comprising updating a display of each GUI element to reflect an associated state of the GUI element.

22. The method of claim 21 wherein each state is one of:
active meaning the GUI element is available for selection by the user, or is actively displaying information relevant to the tile;
contextual meaning the GUI element triggers different workflows based on shopping cart information and or customer information;
inactive meaning the GUI element is not available for selection or is not actively displaying information relevant to the tile; and
destructive meaning the GUI element triggers deletion of information relevant to the tile and/or other tiles.

23. The method of claim 18 further comprising:
receiving a user input associated with one of the GUI elements;
in response to receiving the user input associated with the one of the GUI elements, triggering one of a plurality of different workflows based on shopping cart information and/or customer information.

24. The method of claim 17 further comprising:
determining one of a plurality of configurations based on one or a combination of:
which user is logged into the point of sale device;
which store the point of sale device is located in;
a location of the point of sale device; and
a user group or category associated with the user;
displaying the grid based on the determined one of a plurality of configurations.
